(19) United States
(12) Patent Application Publication
(10) Pub. No.: US 2012/0060360 A1
(43) Pub. Date: Mar. 15, 2012

(54) Polymer electrolyte for lithium battery and method for preparing lithium battery using same

(76) Inventor: Jiansheng Liu, Guangzhou City (CN)

(21) Appl. No.: 13/321,172

(22) PCT Filed: Jun. 2, 2010
(86) PCT No.: PCT/CN2010/073471

§ 371 Date: Nov. 18, 2011

(30) Foreign Application Priority Data
Apr. 9, 2010 (CN) 201010146948.X

(51) Int. Cl. H01M 4/82

(52) U.S. Cl. 29/623.2

(57) ABSTRACT

The present invention discloses a polymer lithium-ion battery manufacturing method. With the method, first preparing the electrolyte, and then injecting the electrolyte into a battery; after aging and activating the semi-product, processes of evacuating, sealing, and capacity grading are required to complete the battery. In order to overcome the defects of the convention batteries in production and performance, the present invention creatively chooses the polymer with appropriate molecular weight and other functional ingredients for the electrolyte, whereby the safety performance, service lifetime, high and low temperature performance and rate capacity of the batteries are significantly improved, and the battery production according to the present invention is simple and ease to perform.

### TECHNICAL FIELD

The present invention relates to a lithium battery manufacturing method, and more particularly to a polymer lithium battery manufacturing method.

### BACKGROUND INFORMATION

As having the advantages of high voltage, high energy density, long cycle lifetime, environment friendly, and no memory effect, etc., lithium batteries have had a rapid development. However the conventional liquid lithium-ion batteries have the potential safety issues, for example, they are leaky and flammable. These drawbacks have been overcome by the polymer lithium-ion batteries, furthermore, as the polymer lithium-ion batteries use soft materials in packaging, its shape design could be more flexible. Thus the polymer lithium-ion batteries have drawn the attention from market, and have been considered as the most promising rechargeable batteries at present.

At present there are mainly three manufacturing methods for polymer lithium-ion batteries.

As disclosed by Bellcore (U.S. Pat. No. 5,296,318), the first method is about using PVDF-HFP, PAN, and PMMA as polymer skeletons, to produce the plasticized positive and negative electrodes and diaphragm respectively. After that, the processes including thermal compound, extraction and absorption are used to produce batteries.

The second one is about dissolving the specific polymers in electrolyte to form a gel polymer electrolyte, and then producing polymer film using the gel polymer electrolyte, meanwhile disposing the polymer film between the electrodes and the diaphragm, and adhering them together to form a polymer battery (U.S. 20070111104) .

The two polymer lithium-ion battery manufacturing methods described above are rather complicated, and have higher requirements on production equipment and process, resulting in high production cost, difficulties to realize production automation, and low working efficiency.

The third one is about adding polymer monomers and initiators into a liquid electrolyte, and injecting the electrolyte into a battery, and through thermal or ultraviolet light initiation, allowing the monomers to polymerize within the battery to obtain the polymer battery (U.S. Pat. No. 6,933,080, CN1526759). Even this method is easy to realize, it is difficult to eliminate the residue of the polymer monomers and initiators and consequently leads to negative impacts on the battery performance.

It is widely believed that the polymer in the electrolyte of li-ion battery is difficult to dissolve or even insoluble, and even if dissolved, the electrolyte made has high viscosity, and is thus difficult to infiltrate into the electrodes when being injected into the battery. The batteries produced by this method have worse performance and are inapplicable in practice.

### SUMMARY OF THE INVENTION

An objective of the present invention is to provide a new type of polymer electrolyte for lithium battery, as well to provide a simple but efficient lithium battery manufacturing method using the electrolyte.

The technical solution adopted by the present invention could be described as follows:
a polymer lithium battery manufacturing method comprises the following steps:
   1. according to the composition of the lithium-ion battery electrolyte, mixing the solvent, lithium salt and additives together to obtain a mixed liquor;
   2. at a temperature of between 0˜60° C., dissolving the polymer in the mixed liquor to obtain a electrolyte;
   3. heating the electrolyte to a temperature of between 25˜80° C. , and injecting the electrolyte into a battery when heated;
   4. after injection, disposing the battery in an environment in which the temperature is not higher than 80° C. for aging for 8˜168 hours;
   5. after pre-charging with a small current of between 0.05˜0.2 C to activate, aging the battery for 8˜96 hours in an environment in which the temperature is not higher than 80° C., and then evacuating, sealing, and capacity grading to complete the battery;
   wherein the electrolyte by weight comprises 0.5˜15% electrochemically inert polymer of molecular weight 5000˜120000, and 6˜18% lithium salt, the rest is non-aqueous solvent.

Furthermore, the electrolyte further comprises 0.5˜8% film forming additive.

Furthermore, the electrolyte further comprises 0˜10% overcharge protection additive.

Furthermore, the electrolyte further comprises 0˜15% fire retardant.

Furthermore, the electrolyte further comprises 0.01˜0.5% surfactant, in order to enhance the wettability of the electrolyte.

Furthermore, the electrolyte further comprises 0.05˜0.5% electrolyte stabilizer, in order to enhance the thermostability of the electrolyte.

The process for the polymer electrolyte according to the present invention is simple and easy to perform; it can be deployed in producing the lithium batteries in a large scale in an easy and efficient way without changing the existing lithium battery manufacturing equipment and process. The polymer li-ion batteries produced using the polymer electrolyte disclosed by the present invention could have the advantages from both liquid lithium batteries and conventional polymer lithium batteries, such as high capacity, high cycle performance, high rate discharge performance, high safety performance and good high and low temperature performance, which are significant for the large-scale commercial production of the polymer lithium batteries.

### BRIEF DESCRIPTION OF DRAWINGS

Further details and advantages of the present invention are explained using embodiments, with reference to the attached drawings. In the drawings:

FIG. 1 is a sectional view of the battery formed using the electrolyte in comparison example 1;

FIGS. 2 and 3 are sectional views of the battery formed using the electrolyte in embodiment 1;

FIG. 4 shows the test results of the cycle performance of the electrolytes in comparison example 1 and embodiments 1 and 2 at room temperature;

FIG. 5 shows the 3 C discharge curves of the batteries respectively using the electrolytes in comparison example 1 and embodiments 1 and 2;

FIG. 6 shows the 0.2 C discharge curves of the batteries respectively using the electrolytes in comparison example 1 and embodiments 1 and 2, at a temperature of −20° C.;

FIG. 7 shows the test results of the cycle performance of the batteries respectively using the electrolytes in comparison example 1 and embodiments 1 and 2, at a temperature of 60° C.

### DETAILED DESCRIPTION OF THE EMBODIMENTS OF THE INVENTION

The present invention breaks with convention, using polymer to prepare the electrolyte for lithium batteries directly. In order to enhance the battery performance, various common additives are added into the electrolyte.

In the present invention the non-aqueous solvent in the electrolyte may be one of any conventional non-aqueous solvents known by those who skilled in the art, including carbonic ester solvent, carboxylic ester solvent, ethers solvent or sulfones solvent. Wherein, the carbonic ester solvent may be ethylene carbonate (EC), propylene carbonate (PC), dimethyl carbonate (DMC), diethyl carbonate (DEC), ethyl methyl carbonate (EMC) or methyl propyl carbonate (MPC); the carboxylic ester solvent may be acid methyl ester, ethyl formate, methyl acetate, ethyl acetate, propyl acetate, ethyl propionate, methyl butyrate, ethyl butyrate, γ-butyrolactone; the ethers solvent may bedimethoxymethane, 1,2-dimethoxyethane, tetrahydrofuran, 1,3-dioxolame; the sulfones solvent may be sulfolane, dimethyl sulfone, diethyl sulfone, methyl ethyl sulfone, methyl propyl sulfone or their combinations. There is no specific limitation of proportion on the solvents above; these can be mixed arbitrarily according to needs.

The polymers used in the present invention are electrochemically inert polymer, of which molecular weights are between 5000˜120000, the polymers may be used solely or mixed with others. Smaller molecular weights may affect the battery performance while overlarge molecular weights may affect the dissolubility of the polymer in solvent, so the molecular weights of the polymers are between 10000˜100000, and preferably 20000˜80000; the content of the polymers in electrolyte less than 0.5% militates against the electrolyte gelation in battery, but more than 10% may result in overlarge viscosity, militating against the use of electrolyte, the preferred amount of the polymer added is 2˜6% of the weight of the electrolyte.

The lithium salt in the electrolyte could be used solely, or in combination, the preferred amount of the lithium salt added is 9˜14% of the weight of the electrolyte.

In the present invention, the film forming additive in the electrolyte may be any film forming additives known by those who skilled in the art, for example: vinylene carbonate (VC), fluoroethylene carbonate (FEC), vinyl ethylene carbonate (VEC), 1, 3-propyl sulfone (1, 3-PS), 1.4-DS, tris (trimethylsilyl) phosphate, tris (trimethylsilyl) borate, TMSpi, or the combination of some of them, as a common knowledge, a film forming additive could be used solely, or in combination with other file forming additives.

The overcharge protection additive in electrolyte may be any overcharge protective additives known by those who skilled in the art, comprising: diphenyl (BP), cyclohexylbenzene (CHB), methylbenzene (MP), anisole and their derivatives, and arene. As a common knowledge, an overcharge protection additive could be used solely, or in combination with others.

The fire retardant in electrolyte may be any fire retardant additives known by those who skilled in the art, comprising: organophosphate, and polyphosphazene compounds, as a common knowledge, a fire retardant additive could be used solely, or in combination with others.

The surfactant in the electrolyte comprises: nonionic surfactant and fluorocarbon macromolecule surfactant, an objective of the surfactant is to enhance the wettability of the electrolyte.

The stabilizer added in the electrolyte comprises: organosilicon compounds with Si—N bonds, acetal compounds, organic amine or imine compounds with C—N or C=N double bonds, fura compounds, isocyanate compounds, iminazole compounds and pyridine compounds. The additives described above enable the electrolyte of the present invention to remain stable at a temperature under 100° C.

A polymer lithium-ion battery manufacturing method according to the present invention comprises the following steps:
1. according to the composition of the lithium-ion battery electrolyte, mixing the solvent, lithium salt and additives together to obtain a mixed liquor;
2. at a temperature of between 0˜60° C., dissolving the polymer in the mixed liquor to obtain a electrolyte;
3. heating the electrolyte to a temperature of between 25˜80° C., and injecting the electrolyte into a battery when heated;
4. after injection, disposing the battery in an environment in which the temperature is not higher than 80° C. for aging for 8˜168 hours;
5. after pre-charging with a small current of between 0.05˜0.2 C to activate, aging the battery for 8˜96 hours in an environment in which the temperature is not higher than 80° C., and then evacuating, sealing, and capacity grading to complete the battery.

In the method described above, the mixing way and order in step 1 are unlimited, and have no impacts on the electrolyte performance, the injection and forming processes are provided by the present invention, other manufacturing methods for battery are known by those who skilled in the art.

Further details and advantages of the present invention are explained using embodiments, but these descriptions should not be regarded as the limitations on the protection scope of the present invention.

Based on the detailed descriptions of the embodiments, those who skilled in the art could understand the advantages and the manufacturing method of the polymer electrolyte disclosed by the present invention more clearly, in the embodiments, the proportions with respect to solvent are mass ratio, while the others with respect to lithium salt, additives and compounds are mass percentage. The electrolyte is prepared under the protection of inert gas in an environment in which the water content is lower than 5 ppm.

### Comparison Example 1

Electrolyte Composition:
lithium salt: LiPF6: 10.0%, LiBF4: 2.0%;
film forming additive: vinylene carbonate (VC) 0.5%, 1, 3-propyl sulfone (1, 3-PS) 5.0%;
surfactant: perfluorootanesulforyl-3-aminopropyltrimethoxy silane 0.05%;
the rest is non-aqueous solvent, of which mass ratio of EC, PC and DEC is 1:1:3.

Preparation method: mixing the non-aqueous solvent, lithium salt and additives homogeneously, to obtain a mixed liquor, blending the mixed liquor while adding the polymer in at a temperature of 10° C. until the polymer is fully dissolved to obtain the polymer electrolyte.

### Embodiment 1

Electrolyte Composition:
polymers: methyl methacrylate polymer, molecular weight 20000, volume of addition 3.0%, vinyl acetate polymer, molecular weight 80000, volume of addition 2.0%;
lithium salt: LiPF6: 10.0%, LiBF4: 2.0%;
film forming additive: vinylene carbonate (VC) 0.5%, 1, 3-propyl sulfone (1, 3-PS) 5.0%;
surfactant: perfluorootanesulforyl-3-aminopropyltrimethoxy silane 0.05%;

the rest is non-aqueous solvent, of which mass ratio of EC, PC and DEC is 1:1:3.

Preparation method: mixing the non-aqueous solvent, lithium salt and additives homogeneously, to obtain a mixed liquor, blending the mixed liquor while adding the polymer in at a temperature of 10° C. until the polymer is fully dissolved to obtain the polymer electrolyte.

### Embodiment 2

Electrolyte Composition:
polymers: methyl methacrylate polymer, molecular weight 60000, volume of addition 3.0%, vinylidene fluoride polymer, molecular weight 16000, volume of addition 1.5%;
lithium salt: LiPF6: 10.0%, LiBF4: 2.0%;
film forming additive: vinylene carbonate (VC) 0.5%, 1, 3-propyl sulfone (1, 3-PS) 5.0%;
surfactant: perfluorootanesulforyl-3-aminopropyltrimethoxy silane 0.05%;
the rest is non-aqueous solvent, of which mass ratio of EC, PC and DEC is 1:1:3.

Preparation method: mixing the non-aqueous solvent, lithium salt and additives homogeneously, to obtain a mixed liquor, blending the mixed liquor while adding the polymer in at a temperature of 10° C. until the polymer is fully dissolved to obtain the polymer electrolyte.

### Embodiment 3

Electrolyte Composition:
polymers: polyvinyl pyrrolidone, molecular weight 120000, volume of addition 2.0%, vinylidene fluoride polymer, molecular weight 50000, volume of addition 1.0%;
lithium salt: LiPF6: 10.0%;
film forming additive: vinylene carbonate (VC) 0.5%, 1, 3-propyl sulfone (1, 3-PS) 1.0%, fluoroethylene carbonate (FEC) 1.5%, tri(trimethylsilane) phosphate 0.5%;
overcharge protection additive: biphenyl (BP) 1%;
fire retardant: tripbenylphosphate 5%, hexachlorocyclotriphosphazene 8%;
electrolyte stabilizer: methyleneisocyanate 0.2%;
the rest is non-aqueous solvent, of which mass ratio of EC, PC, DMC and EMC is 2:1:3:1.

Preparation method: mixing the non-aqueous solvent, lithium salt and additives homogeneously, to obtain a mixed liquor, blending the mixed liquor while adding the polymer in at a temperature of 50° C. until the polymers are fully dissolved to obtain the polymer electrolyte.

### Embodiment 4

Electrolyte Composition:
polymers: methyl methacrylate polymer, molecular weight 12000, volume of addition 5.0%, vinyl acetate polymer, molecular weight 50000, volume of addition 2.0%, cycano carboxycellulose, molecular weight 70000, volume of addition 1.0%;
lithium salt: LiBOB: 10.0%;
film forming additive: vinylene carbonate (VC) 1.0%, 1, 4-butane sultone (1, 4-BS) 1.0%, fluoroethylene carbonate (FEC) 1.5%;
fire retardant: tri-(2,2,2-trifluoroethylvinyl) phosphite ester 10%;
electrolyte stabilizer: imidazopyridine 0.1%;
the rest is non-aqueous solvent, of which mass ratio of EC, MPC, DMC and EPC is 2:1:3:1.

Preparation method: mixing the non-aqueous solvent, lithium salt and additives homogeneously, to obtain a mixed liquor, blending the mixed liquor while adding the polymers in at a temperature of 60° C. until the polymers are fully dissolved to obtain the polymer electrolyte.

### Embodiment 5

Electrolyte Composition:
polymers: acrylonitrile polymer, molecular weight 5000, volume of addition 5.0%, vinyl acetate polymer, molecular weight 60000, volume of addition 1.0%;
lithium salt: LiPF6: 12.6%
film forming additive: vinyl ethylene carbonate (VEC) 1.5%, 1, 4-butane sultone (1, 4-BS) 4.0%, tri-(trimethylsilane) boricacidester 2.5%;
electrolyte stabilizer: imidazopyridine 0.1%, borazine 0.05%;
the rest is non-aqueous solvent, of which mass ratio of EC, MPC, DMC and EPC is 2:1:3:1.

Preparation method: mixing the non-aqueous solvent, lithium salt and additives homogeneously, to obtain a mixed liquor, blending the mixed liquor while adding the polymers in at a temperature of 45° C. until the polymers are fully dissolved to obtain the polymer electrolyte.

### Embodiment 6

Electrolyte Composition:
polymers: vinyl cyanide polymer, molecular weight 50000, volume of addition 5.0%, cellulose acetate butyrate, molecular weight 75000, volume of addition 5.0%;
lithium salt: LiPF6: 10.0%, LiBF4: 1.0%;
film forming additive: vinyl ethylene carbonate (VEC) 1.0%, 1, 4-butane sultone (1, 4-BS) 4.0%, tri-(trimethylsilane) phosphite ester 0.5%;
electrolyte stabilizer: imidazopyridine 0.1%, borazine 0.05%;
the rest is non-aqueous solvent, of which mass ratio of EC, MPC, DMC and EP is 6:1:7:5.

Preparation method: mixing the non-aqueous solvent, lithium salt and additives homogeneously, to obtain a mixed liquor, blending the mixed liquor while adding the polymers in at a temperature of 45° C. until the polymers are fully dissolved to obtain the polymer electrolyte.

### Embodiment 7

Electrolyte Composition:
polymers: the polymer of acrylonitrile and vinyl acetate, molecular weight 50000, volume of addition 2.0%, cellulose acetate butyrate, molecular weight 78000, volume of addition 2.0%
lithium salt: LiPF6: 10.0%, LiSO3CF3: 5.0%;
film forming additive: vinyl ethylene carbonate (VEC) 0.5%, 1, 3-propyl sultone (1, 3-PS) 1.0%;
overcharge protection additive: toluene 8.0%;
electrolyte stabilizer: imidazo pyridine 0.2%, borazine 0.15%
the rest is non-aqueous solvent, of which mass ratio of EC, γ-GBL, DMC and EB is 6:1:7:5.

Preparation method: mixing the non-aqueous solvent, lithium salt and additives homogeneously, to obtain a mixed liquor, blending the mixed liquor while adding the polymers in at a temperature of 60° C. until the polymers are fully dissolved to obtain the polymer electrolyte.

### Embodiment 8

Electrolyte Composition:
polymers: the polymer of methyl acrylate and vinyl acetate, molecular weight 65000, volume of addition 1.5%, cyan acetate butyrate cellulose, molecular weight 50000, volume of addition 1.5%;
lithium salt: LiPF6 10.0%, Li (CF3SO2) 2N 7.0%;
film forming additive: vinyl ethylene carbonate (VEC) 0.5%, 1, 3-propyl sultone (1, 3-PS) 1.0%;
overcharge protection additive: cyclohexylbenzene 8.0%, 4-fluoroanisole 2.0%;
electrolyte stabilizer: imidazo pyridine 0.05%, borazine 0.05%
The rest is non-aqueous solvent, of which mass ratio of EC, EP, DMC and DME is 6:3:5:1.

Preparation method: mixing the non-aqueous solvent, lithium salt and additives homogeneously, to obtain a mixed liquor, blending the mixed liquor while adding the polymers in at a temperature of 60° C. until the polymers are fully dissolved to obtain the polymer electrolyte.

### Embodiment 9

Electrolyte Composition:
polymers: the polymer of vinylidene fluoride and hexafluoropropylene, molecular weight 110000, volume of addition 0.5%, cellulose butyrate propionate, molecular weight 20000, volume of addition 3.0%, polyvinyl pyrrolidone, molecular weight 5000, volume of addition 6.5%;
lithium salt: LiPF6 10.0%, Li (CF3SO2) 2N 1.0%;
film forming additive: vinyl ethylene carbonate (VEC) 1.5%, 1, 3-propyl sultone (1, 3-PS) 0.5%;
fire retardant: di-(2,2,2-trifluoroethyl)-methyl phosphate 7%;
electrolyte stabilizer: N, N-carbonyldiimidazole 0.05%;
The rest is non-aqueous solvent, of which mass ratio of EC, EA, DMC and DOL is 6:3:5:1.

Preparation method: mixing the non-aqueous solvent, lithium salt and additives homogeneously, to obtain a mixed liquor, blending the mixed liquor while adding the polymers in at a temperature of 60° C. until the polymers are fully dissolved to obtain the polymer electrolyte.

### Embodiment 10

Electrolyte Composition:
Polymers: the polymer of vinylidene fluoride and hexafluoropropylene, molecular weight 80000, volume of addition 1.5%, cellulose acetate butyrate, molecular weight 20000, volume of addition 2.0%, cellulose acetate propionate, molecular weight 75000, volume of addition 1.0%;
Lithium salt: LiPF6 12.0%, Li (CF3SO2) 2N 1.0%;
film forming additive: vinyl ethylene carbonate (VEC) 2.0%, 1, 3-propyl sultone (1, 3-PS) 5.0%;
overcharge protection additive: cyclohexylbenzene 4.0%;
fire retardant: hexamethyl phosphazene 2%;
surfactant: perfluorootanesulforyl quaternary ammonium iodine 0.3%;
electrolyte stabilizer: N, N-carbonyldiimidazole 0.05%;
The rest is non-aqueous solvent, of which mass ratio of EC, EMC, DMC and DOL is 6:3:5:1.

Preparation method: mixing the non-aqueous solvent, lithium salt and additives homogeneously, to obtain a mixed liquor, blending the mixed liquor while adding the polymers in at a temperature of 30° C. until the polymers are fully dissolved to obtain the polymer electrolyte.

### Embodiment 11

Electrolyte Composition:
polymers: the polymer of vinylidene fluoride and hexafluoropropylene, molecular weight 25000, volume of addition 1.0%, polyvinylpyrrolidone, molecular weight 20000, volume of addition 14%;
lithium salt: LiPF6 7.0%, Li (CF3SO2) 2N 1.0%;
film forming additive: vinyl ethylene carbonate (VEC) 2.0%, 1, 3-propyl sultone (1, 3-PS) 1.0%;
fire retardant: hexamethyl phosphazene 3%;
electrolyte stabilizer: N, N-carbonyldiimidazole 0.3%;
The rest is non-aqueous solvent, of which mass ratio of EC, EMC, DMC and DOL is 6:3:5:1.

Preparation method: mixing the non-aqueous solvent, lithium salt and additives homogeneously, to obtain a mixed liquor, blending the mixed liquor while adding the polymers in at a temperature of 30° C. until the polymers are fully dissolved to obtain the polymer electrolyte.

### Embodiment 12

Electrolyte composition:
polymers: the polymer of vinylidene fluoride and hexafluoropropylene, molecular weight 50000, volume of addition 6.0%, polyvinylpyrrolidone, molecular weight 50000, volume of addition 4.5%, propylene oxide polymer, molecular weight 20000, volume of addition 1.5%;
lithium salt: LiFP6 6.0%;
film forming additive: vinylene carbonate (VC) 1.0%, 1, 3-propyl sultone (1, 3-PS) 4.0%;
overcharge protection additive: biphenyl 4.0%, parachlorotoluene 3.0%;
surfactant: perfluorootanesulforyl quaternary ammonium oxide 0.5%;
electrolyte stabilizer: N, N-carbonyldiimidazole 0.05%;
The rest is non-aqueous solvent, of which mass ratio of EC, PC, DMC and EP is 6:3:5:1.

Preparation method: mixing the non-aqueous solvent, lithium salt and additives homogeneously, to obtain a mixed liquor, blending the mixed liquor while adding the polymers in at a temperature of 30° C. until the polymers are fully dissolved to obtain the polymer electrolyte.

### Embodiment 13

Electrolyte Composition:
polymers: the polymer of vinylidene fluoride and hexafluoropropylene, molecular weight 20000, volume of addition 2.0%, polyvinylpyrrolidone, molecular weight 80000, volume of addition 0.5%, propylene oxide polymer, molecular weight 15000, volume of addition 8.5%;
lithium salt: LiFP6 14.0%;
film forming additive: vinylene carbonate (VC) 1.0%, vinyl ethylene carbonate (VEC) 0.5%, 1, 3-propyl sultone (1, 3-PS) 3.0%;
overcharge protection additive: biphenyl 4.0%;
surfactant: fattyglyceride 0.45%
The rest is non-aqueous solvent, wherein the mass ratio of EC, PC, DMC and THF is 6:3:5:1.

Preparation method: mixing the non-aqueous solvent, lithium salt and additives homogeneously, to obtain a mixed liquor, blending the mixed liquor while adding the polymers in at a temperature of 30° C. until the polymers are fully dissolved to obtain the polymer electrolyte.

### Embodiment 14

Electrolyte Composition:
polymers: the polymer of methyl methacrylate and oxirene, molecular weight 50000, volume of addition 1.0%, polyvinylpyrrolidone, molecular weight 65000, volume of addition 0.5%, propylene oxide polymer, molecular weight 20000, volume of addition 0.5%;
lithium salt: LiFP6 11.5%, LiODFB 1.5%;
film forming additive: vinylene carbonate (VC) 2.5%, vinyl ethylene carbonate (VEC) 0.5%, 1, 3-propyl sultone (1, 3-PS) 3.0%;

overcharge protection additive: biphenyl 3.0%;
fire retardant: triethyl phosphate 4.0%;
surfactant: perfluorootanesulforyl fluoride 0.4%;
electrolyte stabilizer: ethanolamine 0.05%;
The rest is non-aqueous solvent, wherein the mass ratio of EC, PC, DMC and DEC is 5:1:3:5.

Preparation method: mixing the non-aqueous solvent, lithium salt and additives homogeneously, to obtain a mixed liquor, blending the mixed liquor while adding the polymers in at a temperature of 30° C. until the polymers are fully dissolved to obtain the polymer electrolyte.

### Embodiment 15

Electrolyte Composition:
Polymers: the polymer of methyl methacrylate and oxirene, molecular weight 50000, volume of addition 3.0%, cycano cellulose acetate butyrate , molecular weight 70000, volume of addition 1.0%;
Lithium salt: LiFP6 13.1%, LiBF4 1.6%;
film forming additive: vinylene carbonate (VC) 1.5%, vinyl ethylene carbonate (VEC) 1.5%, 1, 3-propyl sultone (1, 3-PS) 1.5%;
overcharge protection additive: biphenyl 5.0%;
fire retardant: trimethyl phosphite 4.0%, phenoxy cyclotriphosphazene 7%;
surfactant: perfluorootanesulforyl fluoride 0.1%;
electrolyte stabilizer: phenyl isocyanate 0.1%;
The rest is non-aqueous solvent, wherein the mass ratio of EC, PC, EMC and DEC is 3:1:1:5.

Preparation method: mixing the non-aqueous solvent, lithium salt and additives homogeneously, to obtain a mixed liquor, blending the mixed liquor while adding the polymers in at a temperature of 30° C. until the polymers are fully dissolved to obtain the polymer electrolyte.

### Embodiment 16

Electrolyte Composition:
polymers: the polymer of methyl methacrylate and oxirene, molecular weight 50000, volume of addition 2.0%, cyanoethyl cellulose acetate, molecular weight 25000, volume of addition 1.5%;
lithium salt: LiFP6 12.1%, LiBF4 1.6%;
film forming additive: vinylene carbonate (VC) 0.25%, vinyl ethylene carbonate (VEC) 1.5%, 1, 4-butane sultone (1, 4-BS) 0.25%;
overcharge protection additive: biphenyl 3.0%;
fire retardant: hexachlorocyclotriphosphazene 8%;
surfactant: perfluoro-1-octanesulfonyl fluoride 0.3%
electrolyte stabilizer: phenyl isocyanate 0.1%, heptamethyldisilazane 0.01%;
The rest is non-aqueous solvent, wherein the mass ratio of EC, PC, EMC and EA is 3:1:1:5.

Preparation method: mixing the non-aqueous solvent, lithium salt and additives homogeneously, to obtain a mixed liquor, blending the mixed liquor while adding the polymers in at a temperature of 30° C. until the polymers are fully dissolved to obtain the polymer electrolyte.

### Embodiment 17

Electrolyte Composition:
polymers: the polymer of methyl methacrylate and oxirene, molecular weight 30000, volume of addition 0.5%, cyanoethyl cellulose acetate, molecular weight 80000, volume of addition 1.0%;
lithium salt: LiFP6 5.0%, LiBF4 4.0%;
film forming additive: vinylene carbonate (VC) 0.3%, vinyl ethylene carbonate (VEC) 0.3%, 1, 4-Butane sultone (1, 4-BS) 0.4%;
overcharge protection additive: biphenyl 2.0%;
fire retardant: hexachlorocyclotriphosphazene 15.0%;
surfactant: perfluoro-1-octanesulfonyl fluoride 0.2%;
electrolyte stabilizer: phenyl isocyanate 0.1%, heptamethyldisilazane 0.01%;
The rest is non-aqueous solvent, of which mass ratio of EC, PC, EMC and EA is 3:1:1:5.

Preparation method: mixing the non-aqueous solvent, lithium salt and additives homogeneously, to obtain a mixed liquor, blending the mixed liquor while adding the polymers in at a temperature of 40° C. until the polymers are fully dissolved to obtain the polymer electrolyte.

### Embodiment 18

Electrolyte Composition:
polymers: the polymer of acrylonitrile and vinyl acetate, molecular weight 60000, volume of addition 4.5%, cyanoethyl cellulose butyrate, molecular weight 90000, volume of addition 4.5%;
lithium salt: LiFP6 12.1%, LiBF4 1.9%;
film forming additive: vinylene carbonate (VC) 1.5%, vinyl ethylene carbonate (VEC) 1.5%, 1, 4-butane sultone (1, 4-BS) 1.0%;
overcharge protection additive: biphenyl 2.0%;
fire retardant: hexachlorocyclotriphosphazene 8%, trimethyl phosphate 1.0%;
surfactant: Perfluoro-1-octanesulfonyl fluoride 0.05%
electrolyte stabilizer: phenyl isocyanate 0.2%, heptamethyldisilazane 0.3%;
the rest is non-aqueous solvent, wherein the mass ratio of EC, PC, EMC and EA is 3:1:1:5

Preparation method: mixing the non-aqueous solvent, lithium salt and additives homogeneously, to obtain a mixed liquor, blending the mixed liquor while adding the polymers in at a temperature of 55° C. until the polymers are fully dissolved to obtain the polymer electrolyte.

### Embodiment 19

Electrolyte Composition:
Polymers: the polymer of acrylonitrile and vinyl acetate, molecular weight 5000, volume of addition 0.25%, cyanoethyl cellulose acetate, molecular weight 120000
volume of addition 0.25%;
Lithium salt: LiFP6 14%, LiBF4 4.0%;
film forming additive: vinylene carbonate (VC) 1.5%, vinyl sulfone (VS) 1.0%, 1, 4-butane sultone (1, 4-BS) 0.5%;
overcharge protection additive: biphenyl 3.0%;
fire retardant: hexachlorocyclotriphosphazene 0.5%, trimethyl phosphate 0.5%;
surfactant: Perfluoro-1-octanesulfonyl fluoride 0.01%;
electrolyte stabilizer: phenyl isocyanate 0.1%;
The rest is non-aqueous solvent, wherein the mass ratio of EC, PC, EMC and EP is 3:1:3:2.

Preparation method: mixing the non-aqueous solvent, lithium salt and additives homogeneously, to obtain a mixed liquor, blending the mixed liquor while adding the polymers in at a temperature of 0° C. until the polymers are fully dissolved to obtain the polymer electrolyte.

From the above embodiments, those who skilled in the art can easily understand that other similar compounds may be applicable in manufacturing the electrolyte of the present invention.

Some steps for manufacturing a polymer lithium-ion battery:
1. heating the electrolyte to a temperature of between 25˜80° C. , and injecting the electrolyte into a battery when heated;
2. after injection, disposing the battery in an environment in which the temperature is not higher than 80° C. for aging for 8˜168 hours;
3. after pre-charging with a small current of between 0.05˜0.2 C to activate, aging the battery for 8˜96 hours in an environment in which the temperature is not higher than 80° C., and then evacuating, sealing, and capacity grading to complete the battery.

Respectively using the electrolytes made in comparison example 1, embodiment 1 and 2 to manufacture the battery, according to the following steps:
1. heating the electrolyte to 50° C., and injecting the electrolyte into the battery when heated;
2. after injection, aging the battery at 25° C. for 90 hours;
3. pre-charging the battery with a current of 0.1 C to activate, and evacuating, sealing, and capacity grading to complete the battery after aging the battery at 25° C. for 48 hours.

After testing and dissecting the batteries made, the results are as follows:

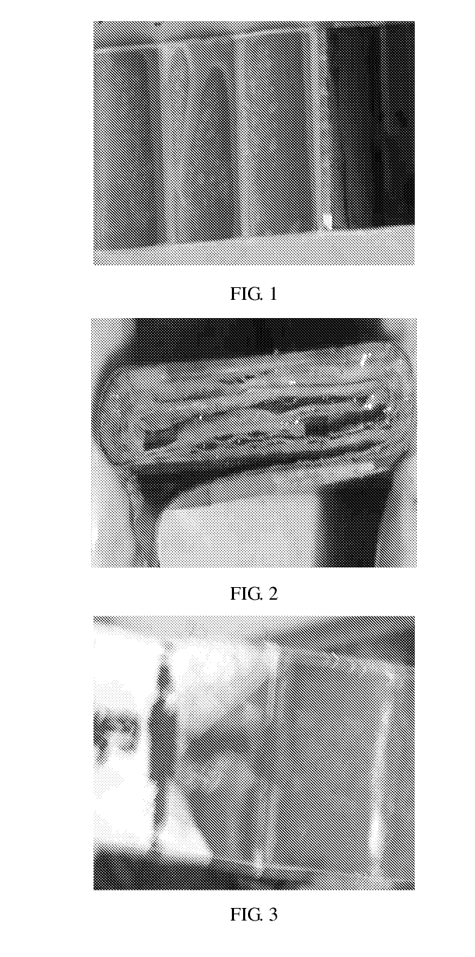

FIG. 1 is a sectional view of the battery formed using the electrolyte in comparison example 1, and FIGS. 2 and 3 are sectional views of the battery formed using the electrolyte in embodiment 1;

FIG. 1 shows, there is a plenty of liquid electrolyte within the battery made using the electrolyte of comparison example 1, and there is no adhesion existing between the electrode plates and the diaphragm.

FIG. 2 shows, there is no liquid electrolyte existing within the battery made using the electrolyte of embodiment 1, the electrolyte is in a gelatinous phase after battery formatting.

FIG. 3 shows, the electrode plates and diaphragm are already adhered together, some active substance still remains on the diaphragm after the electrode plates are ripped off, and this shows the electrolyte of the present invention has excellent wettability and strong adhesion.

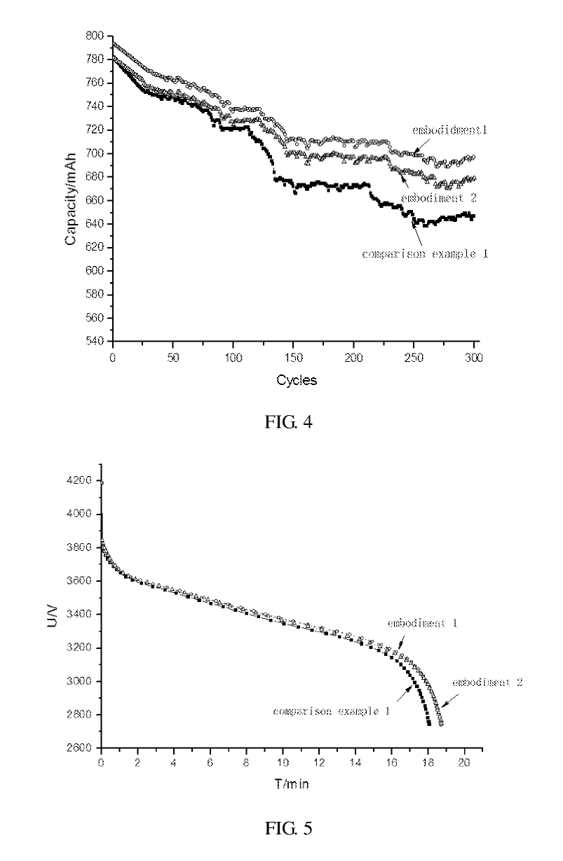

FIG. 4 shows the test results of the cycle performance of the batteries formed respectively using the electrolytes in comparison example 1 and embodiments 1 and 2 at room temperature; from the figure it is obvious that the battery of the electrolyte of the present invention has better cycle performance than comparison example.

FIG. 5 shows the 3 C discharge curves of the batteries formed respectively using the electrolytes in comparison example 1 and embodiments 1 and 2, from the figure it is obvious that the battery of the electrolyte of the present invention has better rate discharge performance.

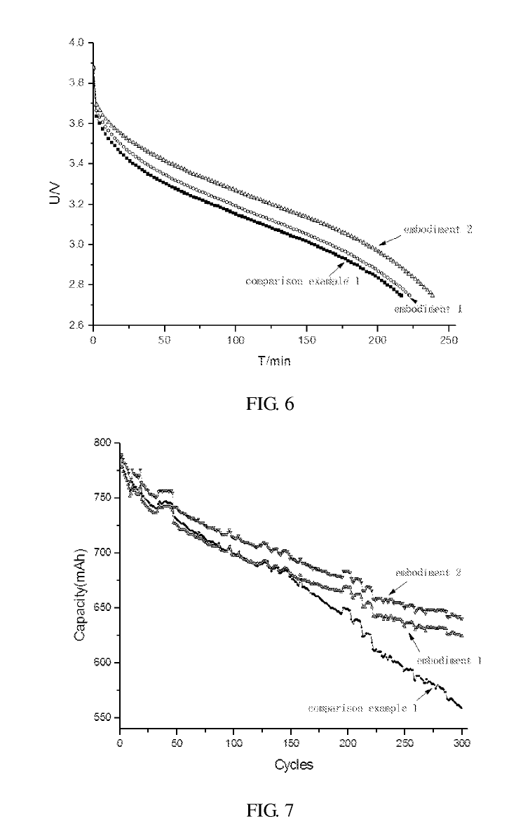

FIG. 6 shows the 0.2 C discharge curves of the batteries made respectively using the electrolytes in comparison example 1 and embodiments 1 and 2, at a temperature of −20° C., from the figure it is obvious that the battery of the electrolyte of the present invention has better low temperature performance.

FIG. 7 shows the test results of the cycle performance of the batteries formed respectively using the electrolytes in comparison example 1 and embodiments 1 and 2, at a temperature of 60° C., from the figure it is obvious that the battery of the electrolyte of the present invention has better cycle performance.

What is claimed is:

1.-9. (canceled)

10. A polymer lithium battery manufacturing method, comprising the following steps:
1) according to the composition of the lithium-ion battery electrolyte, mixing the solvent, lithium salt and additives together to obtain a mixed liquor;
2) at a temperature of between 0˜60° C., dissolving the polymer in the mixed liquor to obtain a electrolyte;
3) heating the electrolyte to a temperature of between 25˜80° C., and injecting the electrolyte into a battery when heated;
4) after injection, disposing the battery in an environment in which the temperature is not higher than 80° C. for aging for 8˜168 hours;
5) after pre-charging with a small current of between 0.05˜0.2 C to activate, aging the battery for 8˜96 hours in an environment in which the temperature is not higher than 80° C., and then evacuating, sealing, and capacity grading to complete the battery;
wherein, the electrolyte by weight comprising 0.5˜15% electrochemically inert polymer of molecular weight 5000˜120000, and 6˜18% lithium salt, the rest is non-aqueous solvent.

11. The polymer lithium battery manufacturing method according to claim 10, characterized in that: the electrolyte further comprises 0.5˜8% film forming additive.

12. The polymer lithium battery manufacturing method according to claim 10, characterized in that: the electrolyte further comprises 0˜10% overcharge protection additive.

13. The polymer lithium battery manufacturing method according to claim 10, characterized in that: the electrolyte further comprises 0˜15% fire retardant.

14. The polymer lithium battery manufacturing method according to claim 10, characterized in that: the electrolyte further comprises 0.01˜0.5% surfactant.

15. The polymer lithium battery manufacturing method according to claim 10, characterized in that: the electrolyte further comprises 0.05˜0.5% electrolyte stabilizer.

16. The polymer lithium battery manufacturing method according to claim 10, characterized in that: the non-aqueous solvent may be carbonic ester solvent, carboxylic ester solvent, ethers solvent or sulfones solvent.

17. The polymer lithium battery manufacturing method according to claim 10, characterized in that: the polymer may be methyl methacrylate polymer, acrylonitrile polymer, propylene-fluoride polymers, tetrafluoroethylene polymer, vinyl acetate polymer, oxirene polymer, propylene oxide polymer, carboxylic acid cellulose, cycano carboxycellulose, polyvinylpyrrolidone or the copolymers thereof.

18. The polymer lithium battery manufacturing method according to claim 10, characterized in that: the lithium salt may be lithium hexafluorophosphate (LiPF₆), lithium tetrafluoroborate (LiBF4), lithium hexafluoroarsenate monohydrate (LiAsF₆), lithium bis (oxalate) borate (LiBOB), lithium Difluoro (oxalato) borate (LiODFB), lithium trifluoromethanesulfonate (LiSO₃CF₃), lithium trifluoromethyl thionylimide (Li (CF₃SO₂) ₂N), or trifluoromethyl thionyl carbonyl lithium (LiC(CF₃SO₂) ₃).
